(19) United States
(12) Patent Application Publication
(10) Pub. No.: US 2026/0007105 A1
(43) Pub. Date: Jan. 8, 2026

(54) CONVEYOR DEVICE FOR USE IN A CUTTING UNIT OF AN AGRICULTURAL HARVESTING MACHINE OR A HEADER

(71) Applicant: CLAAS Selbstfahrende Erntemaschinen GmbH, Harsewinkel (DE)

(72) Inventors: Tamás Zelenyánszki, Békéscsaba (HU); Attila Sándor Göblyös, Törökszentmiklós (HU); Christian Füchtling, Rinkerode (DE)

(73) Assignee: CLAAS Selbstfahrende Erntemaschinen GmbH, Harsewinkel (DE)

(21) Appl. No.: 19/261,124

(22) Filed: Jul. 7, 2025

(30) Foreign Application Priority Data
Jul. 5, 2024 (DE) 10 2024 119 143.0

(51) Int. Cl. A01D 57/20; A01D 61/00; B65G 23/44

(52) U.S. Cl. CPC A01D 57/20; A01D 61/008; B65G 23/44; B65G 2203/0291; B65G 2203/042

(57) ABSTRACT

A conveyor device for use in a cutting unit of an agricultural harvester. The conveyor device includes a frame and at least one conveyor belt which revolves endlessly around two rollers arranged parallel to one another. A distance between the two rollers may be adjusted using a tensioning device. A first roller may be rotatably driven, and a second roller may be mounted to revolve freely. A device for rotational speed detection (associated with the first roller) is configured to detect a rotational speed of the first roller. Further, a second device (associated with the second roller) detect the rotational speed of the second roller during operation of the conveyor belt.

### CROSS REFERENCE TO RELATED APPLICATION

This application claims priority under 35 U.S.C. § 119 to German Patent Application No. DE 10 2024 119 143.0 filed Jul. 5, 2024, the entire disclosure of which is hereby incorporated by reference herein.

### TECHNICAL FIELD

The present invention relates to a conveyor device for use in a cutting unit of an agricultural harvester, a cutting unit for use on an agricultural harvester, and an agricultural harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Cutting units may include, for example, a cutter bar as the cutting device which extends substantially across the entire width of the cutting unit. Furthermore, such cutting units may have at least one conveyor device arranged or positioned behind the cutter bar. The individual conveyor devices serve to transport the harvested material cut by the cutter bar. For this purpose, cutting units may have at least one endlessly circulating center conveyor belt which is associated with a middle section of the cutting unit. The center conveyor belt serves to transport the harvested material along a first transport direction. Furthermore, the cutting units may have a first endlessly circulating side conveyor belt for conveying harvested material along a second transport direction and a second endlessly circulating side conveyor belt for conveying harvested material along a third transport direction. The two side conveyor belts are associated with a side section of the cutting unit. The transport directions of the conveyor belts are aligned in such a way that the second transport direction is aligned opposite the third transport direction, while the first transport direction is aligned at an angle of less than or equal to 90° to the second and third transport directions. In this way, the cut harvested material may be transported along the second and third transport directions in the direction of the center conveyor belt using the first and second side conveyor belts.

Cutting units of the type mentioned above may be referred to as belt cutting units (also known as “draper cutting units”). They may be characterized by a high degree of flexibility when adapting to the ground contour of an area to be processed. This may be achieved by dispensing with a per se rigid cutting unit table, as is typically the case with grain cutting units. For this purpose, the cutting unit has at least one conveyor device with an endlessly circulating, driven conveyor belt which in turn is supported by a plurality of support arms of a given side section of the cutting unit that may pivot about an axis of rotation.

The two rollers of the conveyor belt running parallel to each other are arranged or positioned on the inside at the end so that the conveyor belt may revolve endlessly. The first roller may rotatably be driven, while the second roller is mounted to rotate freely. US Patent Application Publication No. 2018/0332772 A1, incorporated by reference herein in its entirety, discloses a draper with a corresponding conveyor device.

If a conveyor device is overloaded, if there is dirt between the rollers and belt, or if the conveyor belt or roller is damaged, the conveyor belt may experience slip in which the driven roller slips and the peripheral speed is not transferred to the conveyor belt as desired. To monitor the belt speed of the conveyor belt for standstill or slippage, the rotational speed of the driven roller may be detected. Further, sensing wheel (alternatively termed a tracing wheel or tracking wheel) may be arranged or positioned to be in contact with the belt and an associated sensor in order to detect the belt speed.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a top view of an example cutting unit.

FIG. 2 illustrates a perspective, partially cutaway view of a middle section of the cutting unit shown in FIG. 1.

FIG. 3 illustrates a perspective view of a device for detecting the rotational speed of the first driven roller.

FIG. 4 illustrates a perspective view of a device for detecting the rotational speed of the second, co-rotating roller.

FIG. 5 illustrates a section through the second roller from FIG. 4.

FIG. 6 illustrates a block diagram of the agricultural harvester and the cutting unit.

### DETAILED DESCRIPTION

As discussed in the background, to monitor the belt speed of the conveyor belt for standstill or slippage, the rotational speed of the driven roller may be detected. Further, a sensing wheel may be arranged or positioned to be in contact with the belt and an associated sensor in order to detect the belt speed. A comparison of the two sensor signals, such as those of the sensing wheel and the driven roller, may then provide information on slippage of the conveyor belt.

However, dirt may get in between the sensing wheel and the conveyor belt so that the speed of the conveyor belt cannot be reliably determined. It may therefore not always be reliably possible to exactly determine the slip of the conveyor belt.

Thus, in one or some embodiments, a conveyor device is disclosed with at least one conveyor belt of the aforementioned type in which the speed of the conveyor belt may be reliably detected. In particular, the conveyor device may comprise a frame and at least one conveyor belt, which is configured to revolve (such as revolve endlessly) around at least two rollers arranged or positioned parallel to one another. A distance between the two rollers may be adjusted using a tensioning device. A first roller may be rotatably driven (alternatively termed a first driven roller), and a second roller may be mounted to revolve freely. A device (which may be termed a first device or a first roller rotational speed detection device) configured for rotational speed detection may be associated with the first driven roller (alternatively termed a first device configured to determine rotational speed of the first roller). In one or some embodiments, the device is associated in that the position of device is such as to detect the rotational speed of the first roller). In particular, the first device for rotational speed detection may be configured to detect a speed of the first roller. The conveyor device may be suitable for use in a cutting unit of an agricultural harvester. In this case, the conveyor device may, for example, be used as a center conveyor belt and/or as a side conveyor belt. The first roller may, for example, be driven by a motor, such as a hydraulic motor.

The cutting unit may comprise a cutting device for cutting plants standing upright in a field and at least one conveyor device for conveying the cut plants in the direction of a rear transfer opening. The cutting device may, for example, be formed by a mowing bar or cutter bar.

The conveyor device may further include a second device for rotational speed detection of the second roller (alternatively termed a second device or a second roller rotational speed detection device configured to determine rotational speed of the second roller). In this regard, the second device may be associated with the second roller. In particular, the second device for rotational speed detection of the second roller may be configured to detect a rotational speed of the second roller during operation of the conveyor belt. In one or some embodiments, the detection of the rotational speed at the second co-rotating roller may be considerably more reliable than the detection of the belt speed of the conveyor belt via a sensing wheel, as may be practiced in the prior art. Accordingly, the arrangement of a sensing wheel, using the prior art, may be dispensed with. A comparison of the rotational speed of the first driven roller with the rotational speed of the second, freely co-rotating roller may thus make it possible to reliably determine slippage.

In one or some embodiments, the second device for rotational speed detection may comprise: a disk with teeth (that may rotate in the same way as the second roller); and a stationary sensor for detecting passing teeth of the disk. The disk may, for example, be mounted at or on the roller or at or on a component permanently connected to the roller and therefore may “conjointly rotate” with the roller, wherein the disk rotates at the same rotational speed as the roller in principle. This is a technically simple type of rotational speed detection that may be insensitive to various aspects and may operate reliably. Various sensors are contemplated, such as optical or inductive sensors. Other types of sensors are also contemplated.

In one or some embodiments, a shaft segment may be included, which may be non-rotatably connected to the roller at the end, wherein the disk with teeth may be positioned on the shaft segment. In this case, the shaft segment may be directly or indirectly connected to the roller. For example, the shaft segment may be indirectly connected to the roller using a screw (or other means of connection). Advantageously, the shaft segment may be detachably connected to the roller so that it may be removed for maintenance or repair purposes. The fact that the shaft segment is at the end of the roller (where typically no belt runs around the roller) may reduce the possible contamination of the disk located on the shaft segment for rotational speed detection. The provision of the shaft segment may thus represent a simple way of creating sufficient space for the arrangement of the disk with teeth for rotational speed measurement and at the same time arranging the disk at a certain distance from the actual roller in order to keep it farther away (e.g., as far away as possible) from contamination.

In this case, the shaft segment may, for example, be designed as a hollow shaft and connected to the roller by means of a coaxial screw. For this purpose, the roller may have a corresponding axial recess into which the screw is screwed. In another embodiment, the shaft segment may be formed in one piece with the roller, for example, and may be designed as a projection or nose on the end.

In one or some embodiments, an axis of rotation of the roller may correspond to an axis of rotation of the shaft segment.

The arrangement of a detachably fixed shaft segment may also make it possible to retrofit the device for rotational speed detection to existing conveyor devices. The shaft segment may therefore represent a retrofittable modular and detachable axle extension of the roller for the arrangement of the disk.

With regard to the shaft segment, it may be particularly advantageous if the shaft segment is guided through an opening in a frame of the conveyor device and ends on a side of the frame of the conveyor device facing away from the bearing and the second roller, wherein the disk is arranged or positioned on the side of the shaft segment facing away from the bearing and the roller. The second roller may be rotatably mounted at the end on both sides in a bearing, wherein the bearings may, in turn, each be attached to the frame of the conveyor device. This may mean that the second roller is located inside the frame and between the bearings. By providing the disk on the side of the frame facing away from the roller, the distance of the disk and therefore the distance of the device for rotational speed detection to the second roller may be greater, whereby the device for rotational speed detection may be located at a greater distance from a working area of the conveyor belt. As a result, there may be significantly less contamination there so that the reliability of the measurement is further increased. In addition, in this embodiment, the frame of the conveyor may be located between the roller and the device for rotational speed detection, which may act as a kind of barrier against contamination. Furthermore, this design variant may always offer the option of retrofitting the device for rotational speed detection, even in the case of conventional conveyor belts with a supposed lack of space.

Further shaping the conveyor device, a holder may be provided for the sensor, wherein the holder is arranged or positioned in a region of the disk, such as attached directly or indirectly to the frame. The holder may, for example, be attached directly to the frame via screw connections so that it may also be easily retrofitted. The holder may offer a convenient way of mounting the sensor and replacing it if necessary.

Further advantageously shaping for the holder for the sensor, the holder may be attached to a slide movable along the frame. The slide may be designed as a block, disk or similar, wherein the slide may be slidably mounted on the frame. The holder may therefore be indirectly connected to the frame. The slide may be fixed in various positions, such as steplessly, so that the holder with the sensor may be fixed during operation of the conveyor device. The fixation may, for example, be effected solely by a linear drive through which the slide may be moved. The movability of the slide and therefore of the holder may be advantageous since the position of the holder may be adapted or modified in this way to any changes in position of the second roller and therefore of the disk. In one or some embodiments, the holder may be displaceable within a slot in the frame, wherein the slot may further possess a longitudinal axis which may run parallel to a displacement direction of the second roller displaced using the tensioning device. This may mean that the movement of the holder over the slide may be predetermined by the slot in the frame, and the maximum end positions may be predetermined by the holder hitting the two ends of the slot. In one or some embodiments, the slot may be provided with a cover. The movement of the slide may, for example, be effected by the tensioning device. In other words, for example, the slide may be connected to the tensioning device in such a way that the slide may be moved via the tensioning device.

In one or some embodiments, a displacement of the holder may be coupled to a displacement of the second roller by the tensioning device. Therefore, the displacement of the second roller may simultaneously cause a displacement of the holder, and separate actuation of the tensioning device and positioning of the holder may be unnecessary. Typically, the situation with the tensioning device may be such that provided on the second, co-rotating roller so that the second roller may be moved towards and away from the driven roller. In this way, sufficient tension may be applied to the conveyor belt.

In one or some embodiments, the cutting unit may, for example, be a so-called draper cutting unit, which may have a plurality of conveyor devices, each of which may have a conveyor belt. Such a cutting unit may comprise at least two side sections (such as exactly two side sections) and a middle section, wherein a conveyor device is arranged or positioned in each of the side sections. The conveyor devices may serve to convey cut plants towards the middle section using the cutting device. In so doing, the conveyor devices in the two side sections may be operated in opposite directions. Furthermore, such a cutting unit may comprise at least one conveyor device in the middle section. This may be intended to convey the cut plants in the direction of a rear transfer opening so that the plants may be transferred through the transfer opening to a downstream working unit of the harvesting machine. This may be, for example, an inclined conveyor of the harvester on which the cutting unit is suspended.

With regard to an agricultural harvester mentioned above, in particular in the form of a self-propelled combine harvester, the object may be achieved in that the agricultural harvester may include at least one mechanical connector configured to mechanically connect with at least one cutting unit, so that the cutting unit becomes a functional unit of the combine harvester (as part of agricultural harvester). Here too, the advantages of the agricultural harvester (with the cutting unit) may correspond analogously to the above-mentioned advantages of the conveyor device discussed herein.

In one or some embodiments, the agricultural harvester may include a data processing device, which may be in communication with (e.g., wired and/or wirelessly) with the rotational speed detection devices (e.g., the first device configured to detect rotational speed of the first roller and the second device configured to determine rotational speed of the second roller). The data processing device may be configured to automatically process the rotational speeds detected by the respective devices and to automatically compare the detected rotational speeds. Responsive to the data processing device automatically detecting a difference (such as a difference that is greater than a predetermined amount) between the rotational speeds of the first and second roller, it may be assumed from this that the conveyor belt is not rotating properly. In this regard, responsive to this automatic determination, the data processing device may be configured to automatically generate and transmit one or more commands in order to automatically control one or more aspects of the harvester, such as one or more aspects of the conveyor device. In this regard, responsive to this determination, appropriate measures may then be taken.

Finally, in one or some embodiments, the data processing device is configured to automatically generate one or more signals responsive to detection of a difference between the rotational speeds of the first roller and second roller. The signal(s) may, for example, be an output to an operator of the harvester, such as an output of an acoustic signal that may prompt the operator to check operations. Alternatively, or in addition, the signal(s) may comprise one or more commands to automatically modify operation of the harvester, such as automatically reducing the driving speed of the harvester.

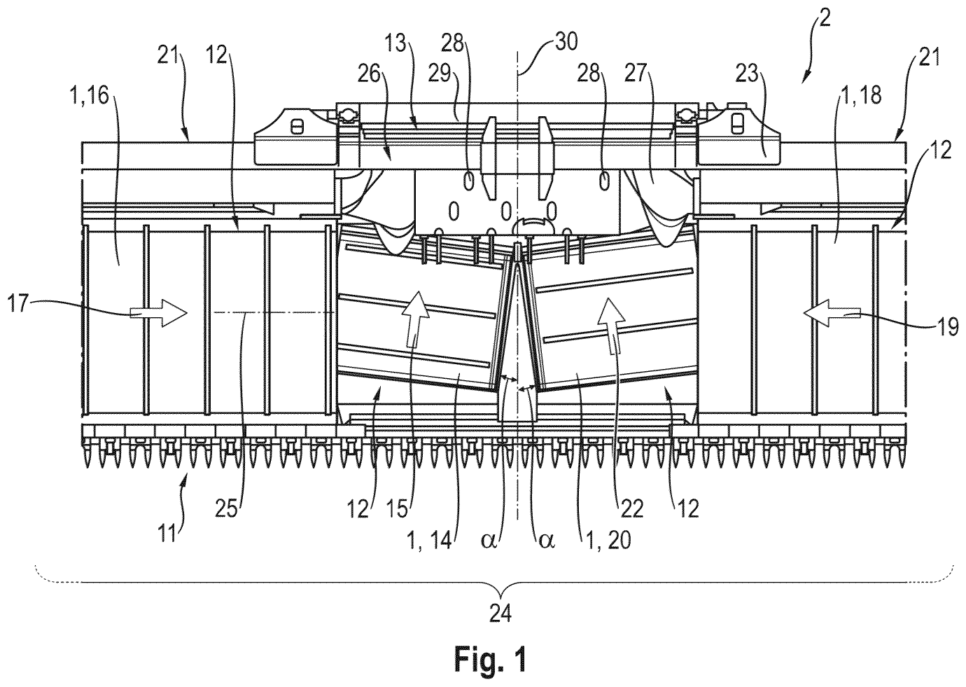

Referring to the figures, FIGS. 1-5 illustrate a cutting unit according one or more aspects of the invention for use in an agricultural harvester, such as in a self-propelled combine harvester. Combine harvesters are disclosed in US Patent Application Publication No. 2023/0397533 A1, US Patent Application Publication No. 2024/0081182 A1, US Patent Application Publication No. 2024/0196796 A1, US Patent Application Publication No. 2025/0048965 A1, each of which are incorporated by reference herein in their entirety. In one or some embodiments, the cutting unit (which may comprise a header of the combine harvester) may comprise a functional unit of the combine harvester. Cutting units are disclosed in US Patent Application Publication No. 2018/0054964 A1, US Patent Application Publication No. 2018/0084724 A1, US Patent Application Publication No. 2018/0168101 A1; and US Patent Application Publication No. 2020/0008341 A1, each of which are incorporated by reference herein in their entirety.

The cutting unit 2 may comprise a draper, which may be distinguished by a high degree of flexibility in adapting to a ground contour of an area to be worked or harvested. Drapers are disclosed in the following: US Patent Application Publication No. 2022/0304235 A1; US Patent Application Publication No. 2022/0304235 A1; US Patent Application Publication No. 2023/0099971 A1; US Patent Application Publication No. 2023/0099974 A1; and US Patent Application Publication No. 2024/0008410 A1, each of which are incorporated by reference herein in their entirety. The cutting unit 2 may include a base frame 23 and may be divided into a middle section 13 and at least two side sections 21 arranged or positioned adjacent to the middle section 13. A cutter bar 11 may be arranged or positioned on the middle section 13 and the side sections 21 on the front side opposite the base frame 23, and may extend at least partly, substantially (e.g., at least 85%, at least 90%, at least 95%), or entirely over the entire width 24 of the cutting unit 2. Furthermore, reels (not shown) may be arranged or positioned on the base frame 23 of the cutting unit 2, and extend over the width 24 of a side section 21 as well as partly over the width 24 of the middle section 13. The reels may serve to help the harvested material to be collected by the cutter bar 11.

The harvested material, which may be separated from the cutter bar 11, may be fed to the cutter bar 11 via one or more conveyor devices 12. In one or some embodiments, the conveyor devices 12 each have endless circulating conveyor belts 1. Two of the conveyor devices 14, 20, which are referred to below as “middle conveyor devices”, may be associated with the middle section 13, while the other two conveyor devices 16, 18 may each be associated with the two side sections 21 and may be referred to below as “side conveyor devices”.

The endlessly circulating conveyor belts 1 of the side conveyor devices 16, 18, associated with the side sections 21, may be arranged or positioned adjacent to the middle conveyor devices 14, 20 associated with the middle section 13 in order to transport the harvested material cut by the cutter bar 11 parallel to a longitudinal axis 25 of the cutting unit 2 in the direction of the middle section 13. For this purpose, the given transport directions 17, 19 may be aligned parallel to the longitudinal axis 25 of the cutter bar 2 and opposite to each other.

In the area of the middle section 13, the harvested material is fed to a feed device 26. The feed device 26 is designed as a drivable feed roller 27 which is mounted on the base frame 23. The feed roller 27 has retractable fingers 28. The feed device 26 may guide the harvested material supplies laterally to the middle section 13 by the endless conveyor belts 1 of the side conveyor devices 16, 18 to a transfer opening provided in the base frame 23 and located behind the feed roller 27, through which the cut harvested material may be transferred to the harvester, such has the combine harvester, for further processing through an feed channel 29 of a combine harvester, to which the cutting unit 2 may be attached, which is shown by way of indication.

Arrows marked with the reference signs 15 and 22 indicate the transport directions of the two middle conveyor devices 14, 20. The two middle conveyor devices 14, 20 may be arranged or positioned inclined to a longitudinal axis 25 of the cutting unit 2. The conveyor belts 1 of the side conveyor devices 16, 18 arranged or positioned adjacent to the side sections 21 may partially overlap the given conveyor belt 1 of the middle conveyor devices 14, 20. In one or some embodiments, the arrangement of the middle conveyor devices 14, 20 is selected such that their conveyor belts 1 are substantially V-shaped. For this purpose, the two middle conveyor devices 14, 20 may be arranged or positioned to converge with each other in the given transport direction 15, 22. The given conveyor belt 1 of the middle conveyor device 14, 20 may form an angle α with the longitudinal axis 30 of the middle section 13, which may be greater than or equal to 5°. The two transport directions 17, 19 of the side conveyor devices 16, 18 may each form an angle of 90°-α to the first transport direction 15 or fourth transport direction 22. The V-shaped arrangement of the conveyor belts 1 of the middle conveyor devices 14, 20 may lead to the harvested material being brought together in the central area of the middle section 13 so that a build-up of harvested material on the middle section 13 towards the side conveyor devices 16, 18 is reduced.

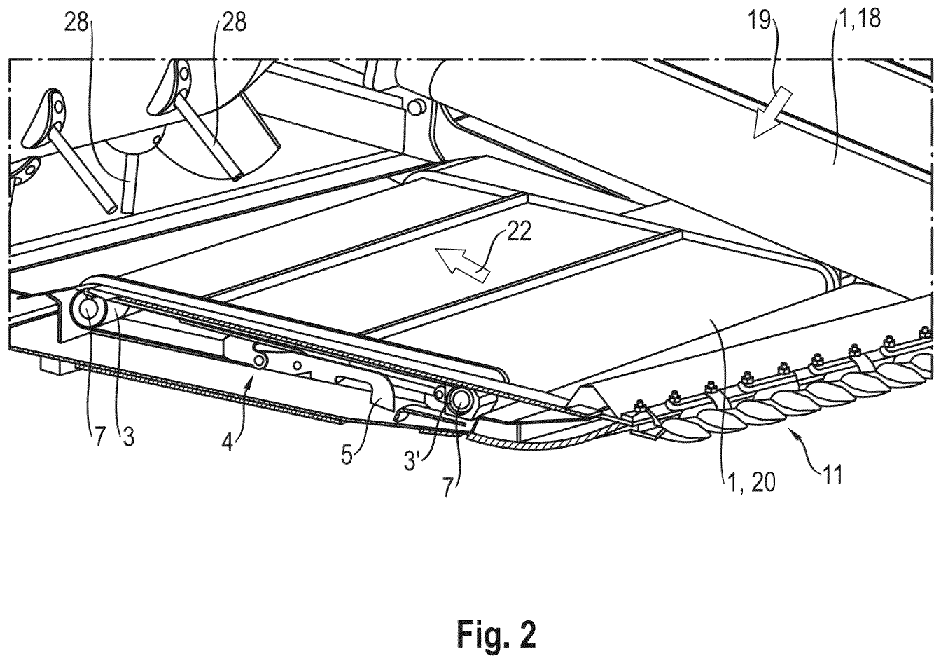

Each of the conveyor devices 12 may have a plurality of rollers, such as two rollers 3, 3′ arranged or positioned on the inside at the ends, which may be arranged or positioned parallel to each other. This is illustrated in FIG. 2, which shows a perspective, partially cutaway partial view of the middle section 13 of the cutting unit 2 according to FIG. 1. In this view, only the conveyor belt 1 of the middle conveyor device 20 is shown. A first roller 3 of the middle conveyor device 20 is designed to be driven by a hydraulic motor 6 of the cutting unit 2, while the second roller 3′ of the conveyor belt 1 is mounted to rotate freely. The driving roller 3 may drive the conveyor belt 1 via a frictional connection. This may require sufficient tension on the conveyor belt 1. This tension may be set and maintained via a (linearly) displaceable roller 3′. The freely rotating roller 3′ may be used as a tensioning roller for the conveyor belt 1. A corresponding tensioning device 4 with an actuating lever 5 is known from the prior art so that this will not be discussed further. The rollers 3, 3′ may each have an axis of rotation 7 around which they rotate.

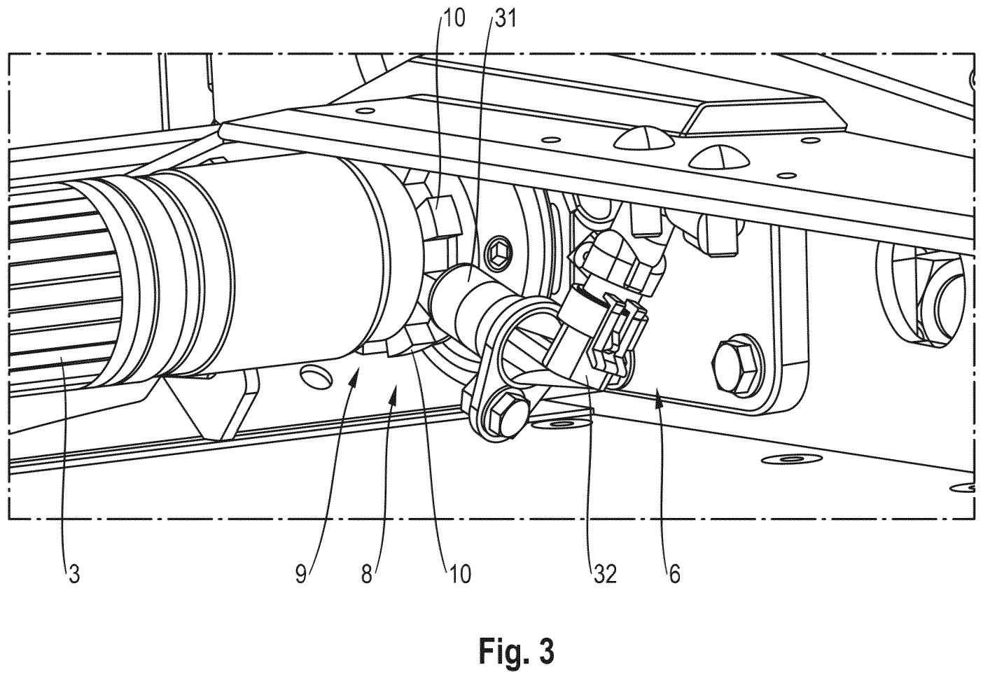

FIG. 3 shows a perspective view of a section of FIG. 2, wherein a device 8 for detecting the rotational speed of the first roller 3, which may be driven in rotation by the hydraulic motor 6, is illustrated. The first roller 3 may include a shaft for the purpose of rotary driving, though this is not explicitly visible in FIG. 3 (e.g., shaft is internal thereto). At an end region of the first roller 3 shown in FIG. 3, a disk 9 with teeth 10 may be arranged or positioned on the shaft, which is connected for conjoint rotation to the shaft and therefore may rotate in the same way or analogously as the shaft and the first roller 3. In one or some embodiments, a sensor 31 is fitted in or affixed in the area of the disk 9, with the sensor 31 being configured to detect the number of teeth 10 that have passed (e.g., generate sensor data indicative of the number of teeth 10 that has passed). The sensor 31, which may comprise an optical sensor, may be attached to a frame 33 of the conveyor belt 1 using a corresponding plug connection 32. The rotational speed of the first roller 3 may thus be deduced from the number of passed teeth 10 (e.g., the analyzing the sensor data indicative of the number of teeth 10 that have passed, the rotational speed of the first roller may be determined).

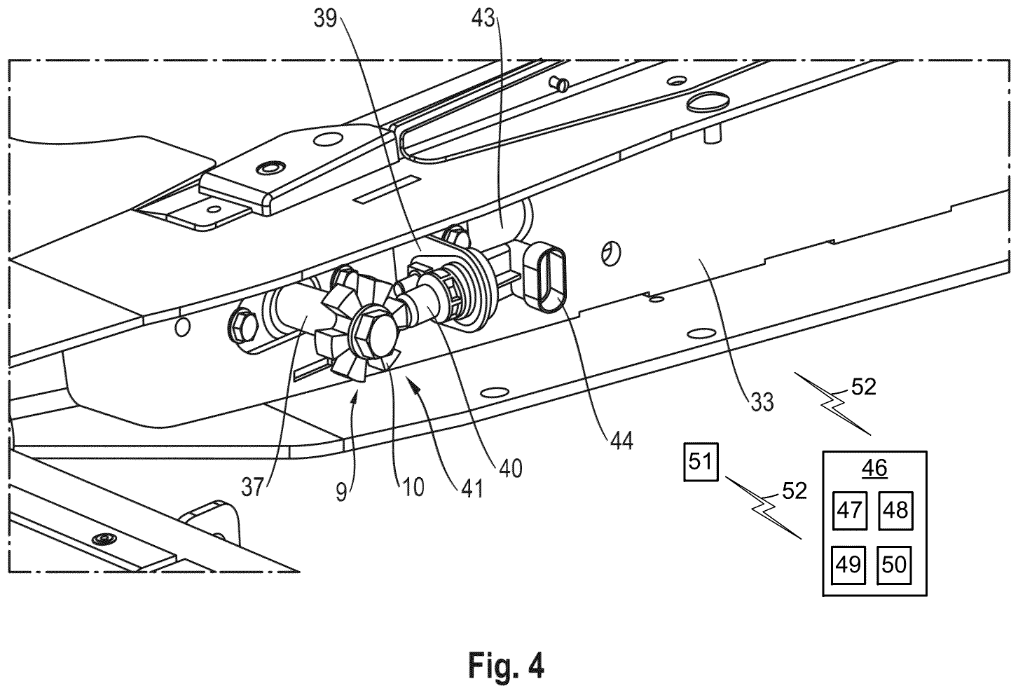

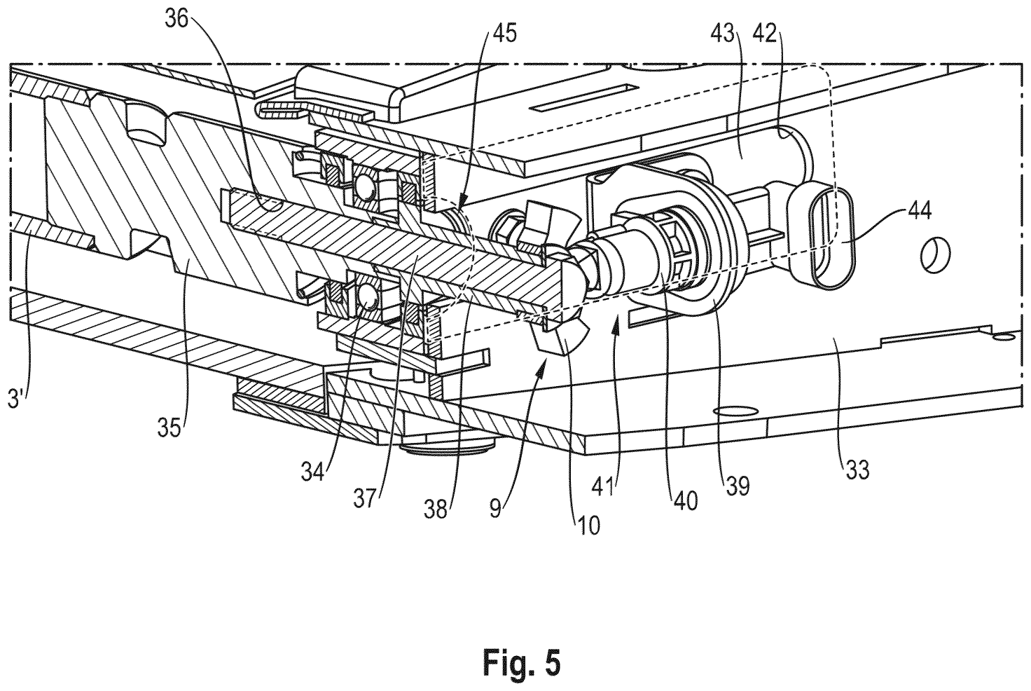

FIGS. 4 and 5 each show a perspective view of a section of FIG. 2, wherein FIG. 5 shows a section through the second roller 3′. Both figures show an end region of the second roller 3′, which is not driven in rotation but is designed for conjoint rotation in a bearing 34 so that the second roller 3′ may rotate about its axis of rotation 7. The second roller 3′ comprises a roller body end piece 35, which may be used for physical mounting in the bearing 34. An opposite end section of the second roller 3′, which cannot be seen in the figures, is constructed and mounted in the same way so that the second roller 3′ rests on both sides in the bearing 34, which in turn may be attached to the frame 33 of the conveyor device 12. In the longitudinal direction of the roller 3′, this accordingly may result in the following component sequence: frame 33; bearing 34; roller body end piece 35; roller 3′; roller body end piece 35; bearing 34; and frame 33.

As may be clearly seen in FIG. 5, a screw 37 is inserted in the roller body end piece 35 which has a corresponding recess 36, wherein an external thread of the screw 37 engages in a corresponding internal thread of the recess 36. As shown, the screw 37 is guided through the bearing 34 of the roller 3′ and through an opening 45 in the frame 33 so that it ends on a side of the frame 33 facing away from the roller 3′. A shaft segment 38 may be arranged or positioned on the screw 37 and may also be guided through the opening 45 in the frame 33 and ends on the side of the frame 33 facing away from the roller 3′. At the end of the shaft segment 38, again on the side of the frame 33 facing away from the roller 3′, a disk 9 with teeth 10 may be attached for conjoint rotation, which may rotate in the same way as the second roller 3′ as well as the roller body end piece 35. The roller 3′, the screw 37, the shaft segment 38 and the washer 9 may run coaxially to each other. The screw 37 may serve to indirectly connect the shaft segment 38 to the roller 3′, wherein other connections between the shaft segment 38 and the roller 3′ are also contemplated.

A sensor 40, which may comprise an inductive sensor, may be attached to the frame 33 of the conveyor device 12 with the aid of a holder 39 and may detect the number of passed teeth 10 so that the current rotational speed of the second roller 3′ may be determined (e.g., sensor 40 may generate sensor data, such as indicative of the number of passed teeth 10; in turn, the sensor data may be analyzed to determine the current rotational speed of the second roller 3′). Accordingly, the second roller 3′ may also have a device 41 for rotational speed detection (e.g., configured to input the sensor data from sensor 40 in order to determine the current rotational speed of the second roller 3′), wherein this may be located on a side of the frame 33 facing away from the roller 3′. In this regard, the device 41 for rotational speed detection may be located outside a working area of the second roller 3′ so that the device 41 may be more protected from contaminants.

The holder 39 for the sensor 40 may be attached to the frame 33 of the conveyor device 12 in such a way that it may be moved within a slot 42. For this purpose, the holder 39 may be attached to a slide 43, which may be displaceable along the frame 33. In one or some embodiments, the slide 43 is formed by a plate to which the holder 39 is in turn screwed. Accordingly, the slide 43 may be located on a side of the frame 33 facing the roller 3′, whereas the holder 39 may be located on a side of the frame 33 facing away from the roller 3′, wherein the holder 39 is guided through the slot 42. The holder 39 may be fixed without steps in various positions so that it remains fixed in its position during operation of the conveyor device 12.

The movable mounting of the holder 39 may be advantageous since changes in the length of the conveyor belt 1 may thereby be compensated for by displacing the second roller 3′. This also may make it possible to move the roller 3′ away from the conveyor belt 1 so that it hangs more loosely and may therefore be removed for maintenance or repair purposes.

In one or some embodiments, a displacement of the holder 39 may be coupled to a displacement of the second roller 3′ using the tensioning device 4. For this purpose, the slide 43 may be connected to the tensioning device 4 in such a way that the slide 43 may be moved using the tensioning device 4.

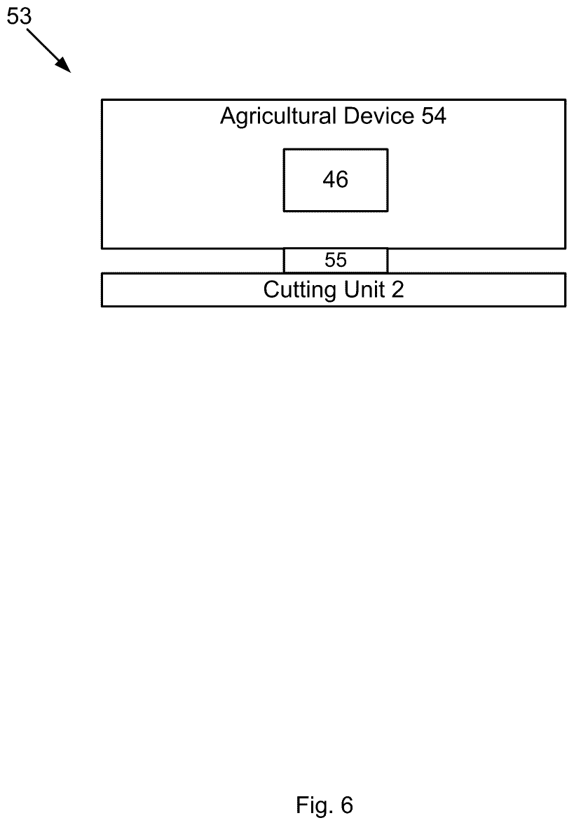

Furthermore, an ISOBUS data connection 44 is shown in FIGS. 4 and 5, via which the data detected by the sensor 40 may be transmitted to a data processing system 46, which may be resident on the harvester. Moreover, FIG. 6 illustrates a block diagram 53 of the agricultural harvester 54, which may comprise a combine harvester. The agricultural harvester 54 may include a mechanical connector 55 in order to mechanically connect with the cutting unit 2 in order for the cutting unit 2 to be a functional unit configured to cut and/or feed to other functional units of the combine harvester (e.g., threshing, cleaning, etc.). For example, the cutting unit 2 may be mechanically connected through a header that includes a cutter bar 11 and a reel. The header may be attached to the front of the combine harvester and is powered by the machine's engine, allowing the cutting unit 2 to cut and gather crops as the combine harvester moves through the field. For example, the cutting unit may be attached to a mounting frame on the front of the combine, which may allow for easy attachment and detachment, with a drive shaft connecting the cutting unit to the combine harvester's power system (e.g., the drive shaft may transmit power from the combine harvester's engine to the cutting unit 2, enabling the cutting unit 2 to operate). Thus, in one or some embodiments, the mechanical connector 55 may comprise a reversible mechanical connector. Alternatively, the mechanical connector 55 may comprise a permanent mechanical connector. Further, the mechanical connection may comprise one or more hydraulic connections in which hydraulic lines connect the cutting unit 2 to the combine harvester's hydraulic system. This may allow for adjustments in height and angle, enabling the operator to customize the cutting height based on crop type and field conditions. Finally, the connection may connection the data processing system 46 in order to control the functions of the cutting unit 2, as discussed herein.

In one or some embodiments, data processing system 46 may comprise at least one processor 47, which may work with at least one memory 48. The memory 48 may be configured to store data, such as sensor data, and/or computer-executable instructions stored on the tangible memory. Moreover, at least one communication interface 49 may be configured to communicate with devices external to the data processing system 46, such as sensor 40, actuator(s) 51, other electronic devices, or the like. Communication (e.g., wired and/or wireless) via the communication interface 49 is shown as 52. Data processing system 46 may further comprise input/output device 50, which may comprise an input device and/or an output device. Examples of input/output device 50 may comprise a touchscreen and/or a speaker (e.g., for generating the audio output or the acoustic signal that may prompt the operator to check operations, as discussed above).

The at least one processor 47 and at least one memory 48 may be in communication (e.g., wired and/or wirelessly) with one another. In one or some embodiments, the processor 47 may comprise a microprocessor, controller, PLA, or the like. Similarly, the memory 48 may comprise any type of storage device (e.g., any type of memory, such as RAM, ROM, or a combination thereof). Though the processor 47 and the memory 48 are depicted as separate elements, they may be part of a single machine, which includes a microprocessor (or other type of controller) and a memory. Alternatively, the processor 47 may rely on the memory 48 for all of its memory needs. The memory 48 may comprise a tangible computer-readable medium that include software that, when executed by the processor 47 is configured to perform any one, any combination, or all of the functionality described herein.

The processor 47 and the memory 48 are merely one example of a computational configuration for the electronic devices discussed herein. Other types of computational configurations are contemplated. For example, all or parts of the implementations may be circuitry that includes a type of processor, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The data processing system 46 may be configured to compare the detected rotational speeds of the first and second rollers 3, 3′ (e.g., the processor 47 is configured to compare sensor data indicative of the rotational speeds of the first and second rollers 3, 3′). Responsive to the data processing system 46 determining a difference between the detected rotational speeds (e.g., the comparison of the sensor data indicates that the rotational speeds of the first and second rollers 3, 3′ differ more than a predetermined amount), the data processing system 46 may determine that the conveyor belt 1 is not rotating properly. Responsive to this determination, the data processing system 46 may control one or more aspects of the harvester and/or the conveyor device 12 and/or the cutting unit 2 (e.g., the control of the one or more aspects in order to reduce the difference in the rotational speeds of the first and second rollers 3, 3′). As one example, the data processing system 46 may send a command to actuator(s) 51 in order to control any one, any combination, or all of the portions as discussed herein, such as the tensioning device 4, the holder 39 (which may be attached to a slide 43 and which may be displaceable, via actuator(s) 51, along the frame 33), one or more rollers (e.g., roller 3′), or the like. In this regard, the data processing system 46 may be configured to modify or adjust various aspects responsive to the determinations discussed herein.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Conveyor belt
2 Cutting unit
3 Roller
3′ Roller
4 Tensioning device
Actuating lever
6 Motor
7 Axis of rotation
8 Device for rotational speed
9 Disk
Tooth
11 Cutter bar
12 Conveyor device
13 Center section
14 Middle conveyor device
First transport direction
16 First side conveyor device
17 Second transport direction
18 Second conveyor device
19 Third transport direction
Second middle conveyor device
21 Side section
22 Fourth transport direction
23 Base frame
24 Width
Longitudinal axis of the cutting unit
26 Feed device
27 Feed roller
28 Finger
29 Feed channel
30 Longitudinal axis of the middle section
31 First roller sensor
32 Plug connection
33 Conveyor device frame
34 Bearing
35 Roller body end piece
36 Recess
37 Screw
38 Shaft segment
39 Second sensor holder
40 Second roller sensor
41 Second device for rotational speed detection
42 Slot
43 Slide
44 ISOBUS data connection
45 Opening
46 Data processing system
47 Processor
48 Memory
49 Communication interface
50 Input/Output device
51 Actuator(s)
52 Communication
53 Block diagram
54 Agricultural harvester
55 Mechanical connector
α Angle

1. A conveyor device for use in a cutting unit of an agricultural harvester, the conveyor device comprising:
a base frame;
at least one conveyor belt configured to revolve around a first roller and a second roller positioned parallel to one another, wherein the first roller is rotatably driven and the second roller is mounted so as to revolve freely;
a tensioning device configured to adjust a distance between the first roller and the second roller;
a first roller rotational speed detection device configured to detect a speed of the first roller; and
a second roller rotational speed detection device configured to detect the speed of the second roller during at least a part of operation of the at least one conveyor belt.

2. The conveyor device of claim 1, wherein the second roller rotational speed detection device comprises:
a disk with teeth configured to rotate in a same way as the second roller; and
a stationary sensor configured to detect passing of the teeth of the disk.

3. The conveyor device of claim 2, further comprising a shaft segment connected for conjoint rotation at an end indirectly or directly to the second roller; and
wherein the disk with the teeth is positioned on the shaft segment.

4. The conveyor device of claim 3, wherein the shaft segment is detachably connected to the second roller.

5. The conveyor device of claim 3, further comprising a conveyor device frame;
wherein the shaft segment is guided through an opening in the conveyor device frame and ends on a side of the conveyor device frame facing away from a bearing and the second roller; and
wherein the disk is positioned on a side of the shaft segment facing away from the bearing and the roller.

6. The conveyor device of claim 2, further comprising:
a holder configured to hold the stationary sensor; and
a conveyor device frame; and
wherein the holder is positioned in a region of the disk on the conveyor device and fastened indirectly or directly to the conveyor device frame.

7. The conveyor device of claim 6, wherein the holder for the stationary sensor is fastened to a slide and configured to displace along the conveyor device frame.

8. The conveyor device of claim 7, wherein the holder is configured to move within a slot in the conveyor device frame.

9. The conveyor device of claim 8, wherein the slot comprises a longitudinal axis which runs parallel to a displacement direction of the second roller configured to be displaced by the tensioning device.

10. The conveyor device of claim 9, wherein the displacement of the holder is coupled to the displacement of the second roller by the tensioning device.

11. A cutting unit for an agricultural harvester, the cutting unit comprises:
a cutting device configured to cut plants standing upright in a field;
one or more conveyor devices configured to convey the cut plants in a direction of a rear transfer opening;
wherein at least one conveyor device of the one or more conveyor devices comprises:
a base frame;
at least one conveyor belt configured to revolve around a first roller and a second roller positioned parallel to one another, wherein the first roller is rotatably driven and the second roller is mounted so as to revolve freely;
a tensioning device configured to adjust a distance between the first roller and the second roller;
a first roller rotational speed detection device configured to detect a speed of the first roller; and
a second roller rotational speed detection device configured to detect the speed of the second roller during at least a part of operation of the at least one conveyor belt.

12. The cutting unit of claim 11, wherein the second roller rotational speed detection device comprises:
a disk with teeth configured to rotate in a same way as the second roller; and
a stationary sensor configured to detect passing of the teeth of the disk.

13. The cutting unit of claim 12, further comprising a shaft segment connected for conjoint rotation at an end indirectly or directly to the second roller; and
wherein the disk with the teeth is positioned on the shaft segment.

14. The cutting unit of claim 13, wherein the shaft segment is detachably connected to the second roller.

15. The cutting unit of claim 13, further comprising a conveyor device frame;
wherein the shaft segment is guided through an opening in the conveyor device frame and ends on a side of the conveyor device frame facing away from a bearing and the second roller; and
wherein the disk is positioned on a side of the shaft segment facing away from the bearing and the roller.

16. An agricultural harvester comprising:
a cutting unit including: a cutting device configured to cut plants standing upright in a field; and one or more conveyor devices configured to convey the cut plants in a direction of a rear transfer opening;
wherein at least one conveyor device of the one or more conveyor devices comprises:
a base frame;
at least one conveyor belt configured to revolve around a first roller and a second roller positioned parallel to one another, wherein the first roller is rotatably driven and the second roller is mounted so as to revolve freely;
a tensioning device configured to adjust a distance between the first roller and the second roller;
a first roller rotational speed detection device configured to detect a speed of the first roller; and
a second roller rotational speed detection device configured to detect the speed of the second roller during at least a part of operation of the at least one conveyor belt.

17. The agricultural harvester of claim 16, further comprising a data processing device configured to:
receive, from the first roller rotational speed detection device, sensor data indicative of the speed of the first roller;
receive, from the second roller rotational speed detection device, sensor data indicative of the speed of the second roller;
compare the speed of the first roller with the speed of the second roller; and
control, based on the comparison of the speed of the first roller with the speed of the second roller, at least one aspect of the agricultural harvester.

18. The agricultural harvester of claim 17, wherein the data processing device is configured to:
responsive to at least a difference between the speed of the first roller with the speed of the second roller, control the at least one aspect of the agricultural harvester.

19. The agricultural harvester of claim 18, wherein the data processing device is configured to automatically control, responsive to automatically determining the at least the difference between the speed of the first roller with the speed of the second roller, the at least one aspect of the agricultural harvester in order to reduce the difference between the speed of the first roller with the speed of the second roller.

20. The agricultural harvester of claim 19, wherein the data processing device is configured to automatically control, responsive to automatically determining the at least the difference between the speed of the first roller with the speed of the second roller, the tensioning device.
